(19) United States
(12) Patent Application Publication
(10) Pub. No.: US 2025/0252337 A1
(43) Pub. Date: Aug. 7, 2025

(54) SUPPRESSION OF CORRELATED NOISE IN QUANTUM COMPUTERS

(71) Applicant: International Business Machines Corporation, Armonk, NY (US)

(72) Inventors: Seyed Alireza Seif Tabrizi, Adelphi, MD (US); Ali Javadiabhari, Sleepy Hollow, NY (US); Moein Malekakhlagh, Elmsford, NY (US); Petar Jurcevic, New York, NY (US); Kevin Daniel Krsulich, Ridgefield, CT (US); Vinay Tripathi, Los Angeles, CA (US); Haoran Liao, El Cerrito, CA (US)

(21) Appl. No.: 18/432,658

(22) Filed: Feb. 5, 2024

(51) Int. Cl. G06N 10/70; G06N 10/20

(52) U.S. Cl. CPC G06N 10/70; G06N 10/20

(57) ABSTRACT

Systems and techniques that facilitate quantum noise suppression are provided. For example, one or more embodiments described herein can comprise a system, which can comprise a memory that can store computer executable components. The system can also comprise a processor, operably coupled to the memory that can execute the computer executable components stored in memory. The computer executable components can comprise an error detection component that determines one or more portions of a quantum circuit susceptible to noise errors; and an error reduction component that adds one or more dynamical decoupling sequences to the one or more determined portions of the quantum circuit wherein the one or more dynamical decoupling sequences are determined based on context of circuit layers of the quantum circuit.

### BACKGROUND

The subject disclosure relates to suppression of correlated noise in quantum computers, and more specifically to suppression of correlated noise in quantum computers via context-aware compiling.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate suppression of correlated noise in quantum computers are provided.

According to an embodiment, a system can comprise a processor that executes computer executable components stored in memory. The computer executable components can comprise an error detection component that determines one or more portions of a quantum circuit susceptible to noise errors; and an error reduction component that adds one or more dynamical decoupling sequences to the one or more determined portions of the quantum circuit wherein the one or more dynamical decoupling sequences are determined based on context of circuit layers of the quantum circuit. An advantage of such a system is that by selecting dynamical decoupling sequences based on context of circuit layers, conflicting dynamical decoupling sequences can be avoided, thus improving fidelity of the quantum circuit during execution.

According to another embodiment, a computer implemented method can comprise determining, by a system operatively coupled to a processor, one or more portions of a quantum circuit susceptible to noise errors; and adding, by the system, one or more dynamical decoupling sequences to the one or more determined portions of the quantum circuit, wherein the one or more dynamical decoupling sequences are determined based on context of circuit layers of the quantum circuit. An advantage of such a method is that by selecting dynamical decoupling sequences based on context of circuit layers, conflicting dynamical decoupling sequences can be avoided, thus improving fidelity of the quantum circuit during execution.

According to another embodiment, a computer program product comprising a computer readable storage medium having program instructions embodied therewith, the program instructions executable by a processor to cause the processor to determine one or more portions of a quantum circuit susceptible to noise errors; and add one or more dynamical decoupling sequences to the one or more determined portions of the quantum circuit, wherein the one or more dynamical decoupling sequences are determined based on context of circuit layers of the quantum circuit.

### DESCRIPTION OF THE DRAWINGS

FIG. 1 illustrates a block diagram of an example, non-limiting system that can facilitate context aware quantum noise suppression and compensation in accordance with one or more embodiments described herein.

FIG. 2 illustrates various error cases in accordance with one or more embodiments described herein.

FIG. 3A illustrates an illustrates an example of error suppression for a quantum circuit utilizing context aware dynamical decoupling as described herein in accordance with one or more embodiments,

FIG. 3B illustrates seven labels and corresponding Walsh-Hadamard sequences utilized for error suppression in accordance with one or more embodiments described herein.

FIGS. 4A-7B illustrate examples of noisy circuits wherein the noise errors have been suppressed and/or compensated using one or more techniques described herein and graphs illustrating improvements in circuit fidelity.

FIG. 8 illustrates a flow diagram of an example, non-limiting, computer-implemented method that can facilitate context aware error suppression in accordance with one or more embodiments described herein.

FIG. 9 illustrates a flow diagram of an example, non-limiting, computer-implemented method that can facilitate context aware error compensation in accordance with one or more embodiments described herein.

FIG. 10 illustrates a flow diagram of an example, non-limiting, computer-implemented method that can facilitate context aware error compensation and suppression in accordance with one or more embodiments described herein.

FIG. 11 illustrates a graph comparing the performance of a Floquet Ising evolution with and without context aware error compensation in accordance with one or more embodiments described herein.

FIG. 12 illustrates a graph comparing the performance of a Heisenberg model using error suppression and error compensation as described herein and existing methods.

FIG. 13 illustrates a graph comparing performance benchmarks of fidelity of a 10 qubit with 3 ECR gates and 4 idle qubits in accordance with one or more embodiments described herein.

FIG. 14 illustrates an example, non-limiting algorithm for context aware error suppression in accordance with one or more embodiments described herein.

FIG. 15 illustrates an example, non-limiting algorithm for context aware error compensation in accordance with one or more embodiments described herein.

FIG. 16 illustrates a block diagram of an example, non-limiting system that can complete execution of a quantum job in accordance with one or more embodiments described herein.

FIG. 17 illustrates an example, a non-limiting environment for the execution of at least some of the computer code in accordance with one or more embodiments described herein.

Appendix A is a detailed paper describing various embodiments and is to be considered part of this patent specification.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

As quantum computers grow in size and complexity, characterization, suppression, mitigation and correction of errors becomes increasingly important. Error suppression can be used as a first line of defense, as it can prevent some forms of errors from surfacing with relatively small, constant overhead. In contrast, error mitigation can remove errors from large computations (e.g., those involving large numbers of qubits and/or quantum gates), but has relatively large overhead, thereby limiting its effectiveness as quantum computers grow. Finally, error correction can remove errors with polynomial or potentially constant circuit overhead, but the overhead can be large. Accordingly, in both error mitigation and correction, the overhead can be significantly reduced if error suppression is deployed well, thereby reducing the need for error mitigation and error correction, ultimately leading to a reduction in overhead operations.

Among the variety of quantum error types, coherent quantum noise can impact accuracy quadratically more than incoherent (e.g., stochastic) errors. Therefore, accurate characterization and suppression of coherent noise can both significantly improve accuracy of quantum computations and reduce overhead of performing such computations by reducing the amount of error mitigation and error correction. Dynamical decoupling (DD) can effectively be utilized for error suppression of coherent and temporally correlated single qubit noise in quantum circuits. However, going beyond the single qubit case and effectively inserting DD into quantum circuits at large scale is a challenging task. For example, the quantum compiler must be aware of different crosstalk terms in the device Hamiltonian, noise spectrums on the qubits, and the physical gate calibrations used. Furthermore, the temporal and spatial structure of the circuit being executed plays an important role in determining the best sequences of DD gates to use. There are also situations in which DD cannot be applied. For example, when qubits are actively participating in a gate, DD gates and/or pulses cannot be applied as the qubits are already in use. Furthermore, the gates used in DD sequences are themselves non-ideal and can introduce systematic errors and possibly cross talk. Finally, DD sequences can call for precise timing requirements which may be difficult to fulfill, especially in cases of classical measurement and feed-forward operation.

In view of the problems discussed above, in relation to quantum error suppression, the present disclosure can be implemented to produce a solution to one or more of these problems by determining one or more portions of a quantum circuit susceptible to coherent noise errors and adding one or more dynamical decoupling sequences to the determined portions of the quantum circuit, wherein the one or more dynamical decoupling sequences are determined based on context of circuit layers of the quantum circuit. This enables arbitrary circuits to be dressed with appropriate DD sequences based on the special and temporal context of both the quantum circuit and the quantum hardware utilized to execute the quantum circuit. In one or more embodiments, a coloring algorithm can be utilized to label the interaction graph of the quantum circuit at each layer of the quantum circuit based on the contents of the layer and the underlying quantum hardware. Accordingly, appropriate DD sequences can be selected that provide error mitigation to one or more qubits without introducing additional errors or cross talk between qubits.

In a further embodiment, the present disclosure can be implemented to compensate for coherent noise errors by compiling the inverse of the noise errors into the quantum circuit based on the spatial and temporal context of the quantum circuit. For example, some quantum errors are well characterized and remain constant over long periods of time, such as always-on ZZ and Stark shift errors. Accordingly, there is more flexibility as to when these errors can be compensated for. In an embodiment, one or more quantum gates preceding or succeeding the occurrence of the noise errors can be selected, and the selected gates can be compiled to absorb the inverse of the noise errors transformed into the selected gates.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

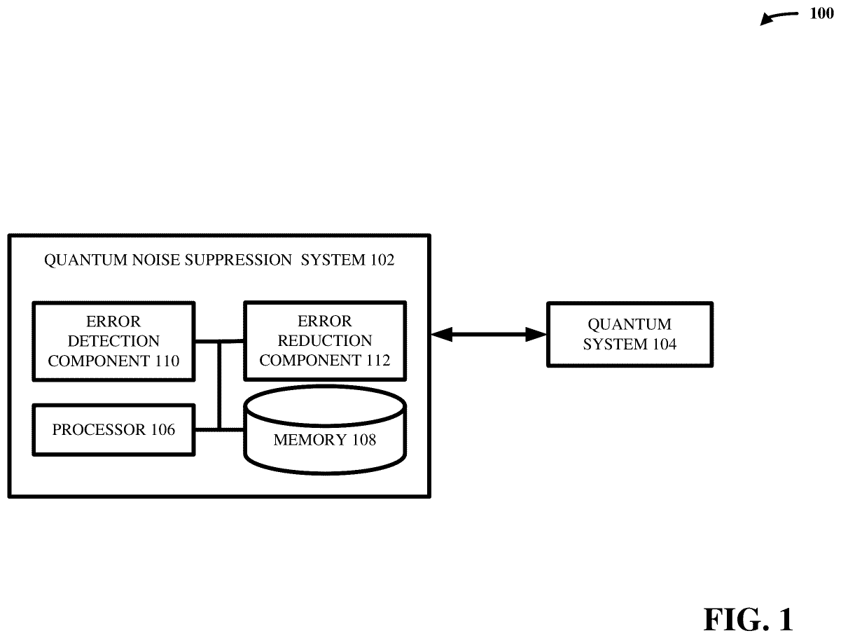

FIG. 1 illustrates a block diagram of an example, non-limiting system 100 that can facilitate suppression of quantum noise in accordance with one or more embodiments described herein. Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise error detection component 110, error reduction component 112, quantum system 104, processor 106 and memory 108.

In various embodiments, quantum noise suppression system 102 can comprise a processor 106 (e.g., a computer processing unit, microprocessor) and a computer-readable memory 108 that is operably connected to processor 106. The memory 108 can store computer-executable instructions which, upon execution by the processor, can cause the processor 106 and/or other components of the quantum noise suppression system 102 (e.g., error detection component 110 and/or error reduction component 112) to perform one or more acts. In various embodiments, memory 108 can store computer-executable components (e.g., error detection component 110 and/or error reduction component 112), and the processor 106 can execute the computer-executable components.

In one or more embodiments, error detection component 110 can determine portions of a quantum circuit susceptible to noise errors, such as crosstalk and coherent errors. Quantum crosstalk refers to an intended quantum operation on a subset of qubits having an unintended action on one or more qubits. The nature and strength of crosstalk depends on the specific implementation of the quantum information processing device (e.g., quantum processor) and the quantum circuit being executed on the quantum processor. Crosstalk can be generated during single and two-qubit gates, state-preparation, measurement, and idle times. A prevalent coherent two-qubit crosstalk error in superconducting architecture is the always-on ZZ interaction. This can originate from coupling to higher levels of the qubits and is often more problematic for fixed-frequency architectures. The Hamiltonian describing this error on a pair of qubits is

$${H}_{11} = \frac{v}{2} ( - I ⊗ Z - Z ⊗ I + Z ⊗ Z ) ,$$

where v is the strength of coupling that varies from pair to pair. This Hamiltonian indicates that qubits accumulate a phase where both the qubits are in the excited state |1 [symbol] . Therefore, nearest-neighboring qubits experience an error of the form U₁₁=R_{zz}(θ)·[R_{z}(−θ) ⊗R_{z}(−θ)], where θ=vτ, when the qubits are idle for time τ. When applying a gate, qubits are driven, which alters this error. A major error that affects the spectator qubits (e.g., qubits in the vicinity of the qubits that the gate acts on) is a coherent Z rotation generated by

$${H}_{s} = \frac{v}{2} Z$$

which leads to error R_{z}(θ).

Accordingly, error detection component 110 can receive a quantum algorithm or quantum circuit design that is to be executed on quantum hardware 104. Error detection component 110 can stratify the quantum circuit into layers. By stratifying the circuit into layers, a structure is introduced that enables simplification of classification/detection and suppression of noise errors in the layers based on the context. The alternating layer structure readily allows for overhead-free compensation of single-qubit coherent errors that occur only on idling qubits in layers of two-qubit gates by absorbing their inverses into the layers of single-qubit gates following or preceding them. The two-qubit coherent errors can be compensated with no overhead if there are generic two-qubit gates before or after them. Moreover, the structure imposed on the two-qubit gate layers simplifies the alignment of DD pulses to improve error suppression.

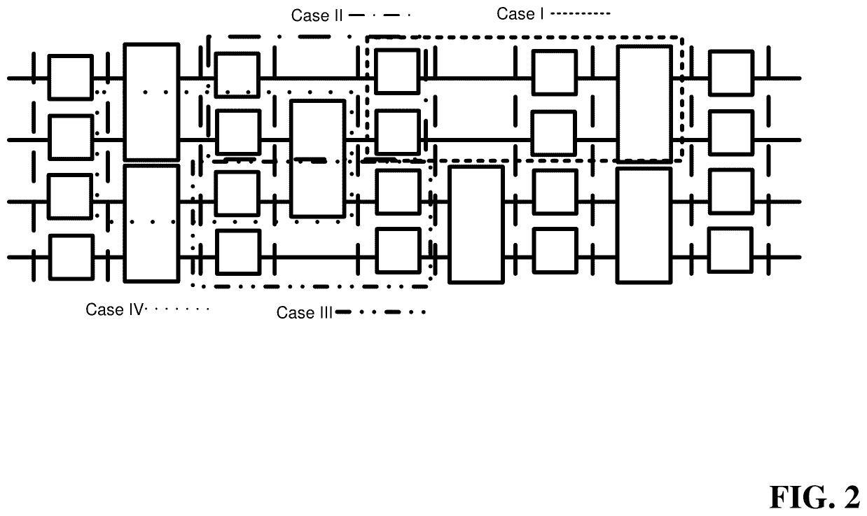

Turning to FIG. 2, cases of errors detectible by error detection component 110 are illustrated in accordance with one or more embodiments described herein. Case 1 occurs when there are two adjacent idle qubits for some period of time 7L. In this case, the qubits are affected by a coherent two-qubit error Hamiltonian H₁₁, wherein

$${H}_{11} = \frac{v}{2} ( - I ⊗ Z - Z ⊗ I + Z ⊗ Z ) .$$

Therefore, the total error is given by U₁₁=R_{zz}(θ)·[R_{z}(−θ) ⊗R_{z}(−θ)], where θ=vτ. When these errors are followed by a Pauli twirling layer and an arbitrary two-qubit gate, the R_{z} terms can be compensated in the single qubit layer and the R_{zz} can be moved past the twirling gates and compensated by the two-qubit gate that follows. Alternatively, context aware staggered DD sequences can also suppress these errors. However, if DD is applied on individual qubits without considering the context, the X gates in DD pulses align and cannot fully suppress the U₁₁ error. Specifically, while aligned DD pules cancel the R_{z}(−θ) terms, it cannot suppress R_{zz}(θ). In this case, the remaining error term can be compensated in the following two qubit gates.

Cases II and III involve spectator qubits of ECR gates. The ECR gate has an echo pulse (X) on its control and rotary echo pulses on its target. These pulses act as DD sequences and cancel the ZZ interaction between the control qubit and its spectator, as well as the target qubit and its spectator. Case IV occurs where the control qubits in two parallel ECR gates are adjacent. Here the gate echo pulses on the control qubits align with each other and the ZZ error reappears. Returning to FIG. 1, error detection component 110 can utilize the context of a quantum circuit (e.g., the temporal and spatial layout of the circuit) in order to identify error cases such as Cases I-IV. Once the error detection component 110 identifies portions of the circuit that are likely to suffer from these error cases, the portions of the circuit can be passed to error reduction component 112 for error suppression and/or compensation.

It should be appreciated that in one or more embodiments, error detection component 110 can detect additional error cases beyond those described in detail in relation to FIG. 2. For example, in one or more embodiments, errors such as AC Stark shift, next-nearest neighbor ZZ interaction, and slow Z oscillations from charge-parity fluctuations can be identified. A driven nonlinear quantum oscillator experiences a dynamic change in its effective frequency, referred to as the AC Stark shift. In weakly-anharmonic superconducting qubits such as transoms, the higher states can introduce non-negligible corrections. Within quantum processors, applying an ECR gate on a control qubit, or a single qubit gate on a qubit can lead to a non-negligible effective drive on its neighbors through the always-on qubit-qubit interactions. This drive spill-over can lead to Stark shift on spectator qubits in the form of Z errors.

In addition to Stark shift, there are other Z errors caused by charge-parity fluctuations through quasi-particle tunneling. Such errors cause a phase shift, whose frequency 6 changes very slowly, but its sign switches from shot to shot. That is, the single qubit error Hamiltonian with strength v, includes an additional ±δZ term

$$H = \frac{1}{2} ( v \pm δ ) Z .$$

As the sign of the additional term is stochastic, dynamical decoupling can remove these errors. ZZ interaction can also occur between Next-Nearest-Neighboring (NNN) qubits. Dependent on proximity to frequency collisions, qubit triplets can occur in which such longer-range ZZ interactions can be undesirably enhanced to [symbol] (10 kHz).

In order to identify portions of the input quantum circuit susceptible to noise errors that can be suppressed and/or corrected, error detection component 110 can build a qubit crosstalk graph based on knowledge of the device Hamiltonian from calibration and crosstalk characterization data. This can include having an edge between neighboring qubits, but in some collision conditions, there may be additional edges connecting NNN. Then, the layers of the quantum circuit are scanned to identify idle periods (e.g., portions of the quantum circuit) which may be candidates for DD sequence insertion or error correction, depending on their duration and the characteristics of the respective qubits. These periods are greedily collected into groups of delays which overlap in time and are adjacent on the qubit crosstalk graph. The collected groups of delays are then passed to error reduction component 112 which can select appropriate DD sequences to apply. In another embodiment, error detection component 110 can initialize a dictionary mapping each qubit and each pair of qubits in the connectivity graph to the final error compensation accumulated on those qubits. This is initially Z(0) for individual qubits and ZZ(0) for pairs of qubits. This dictionary mapping can then be passed to error reduction component 112, which can compile error corrections based on the dictionary mapping. Accordingly, the groups of delays, the qubit crosstalk graph and the dictionary mapping represent portions of the quantum circuit susceptible to quantum noise errors.

In one or more embodiments, error reduction component 112 can add one or more DD sequences to the determined portions of the quantum circuit to suppress noise errors. Dynamical decoupling (DD) is an open-loop control technique used for error suppression originating from coupling to unwanted interactions. The central premise of DD is to apply a sequence of gates that effectively average the unwanted interaction Hamiltonian to zero. Consider a pure dephasing noise model where the unwanted interaction is given by

$${H}_{s} = \frac{v}{2} Z .$$

Under such a model, the evolution of the system subjected to coherent phase noise for time 2r is characterized by the time-evolution unitary U_{S}=R_{z}(2θ), where θ=vτ. If two X pulses are applied at the beginning and in the middle of evolution, the effective dynamics can be described by Uₛ′=XR_{z}(θ)XR_{z}(θ). By noting that XR_{z}(θ)X=R_{z}(−θ), the expression can be simplified to Uₛ′=I. For stochastic colored noise, this cancellation is no longer exact, but a DD sequence can still be utilized to suppress the errors to order of τ². To suppress a coherent two qubit ZZ error in addition to single qubit Z errors, DD pulses can be applied on two qubits in a staggered fashion. This is because X⊗X from DD commutes the unwanted Z⊗Z, and there will not be any cancellation if the pulses are aligned. However, staggering pulses ensure that there are periods of evolution accumulating opposite phases that eventually cancel and fully suppress the unwanted interactions.

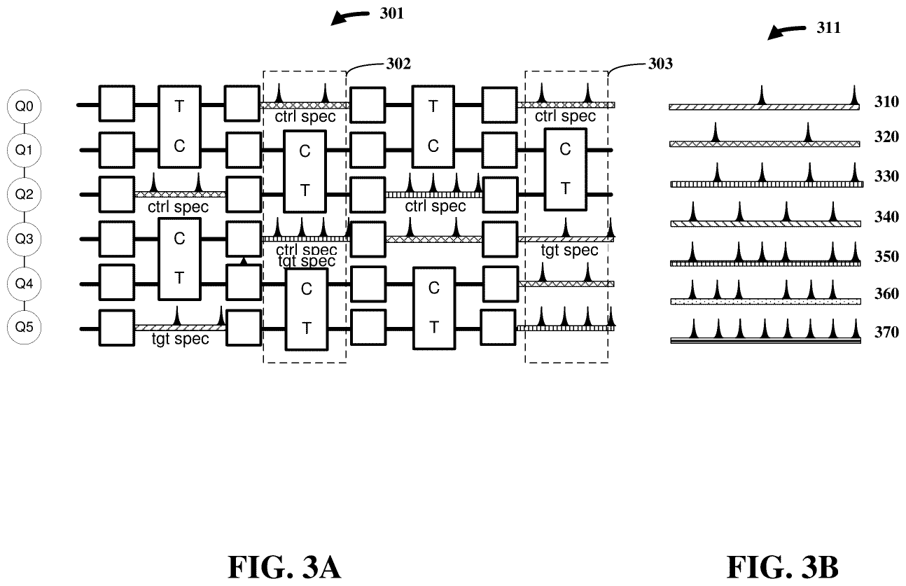

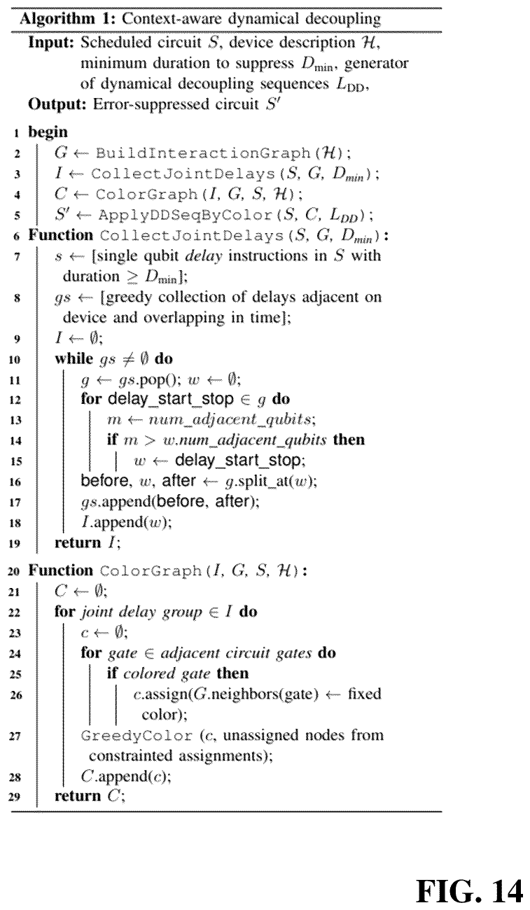

Accordingly, error reduction component 112 can evaluate the groups of delays collected by error detection component 110 recursively, examining the entry and exit of each variable-width delay instruction to identify the longest time period and largest collection of qubits which are candidates for DD based on the duration, crosstalk, interaction, and number of jointly idling qubits. The remainder of the group is split and each residual is evaluated in the same way. These delay groups are then analyzed within their circuit and device context to select and insert a DD sequence for error suppression. This can include examining the circuit context to account for concurrent gates on qubits adjacent to the idling group as shown in FIG. 2. These provide constraints in a search to assign decoupling sequences such that adjacent sequences do not align and negate the effect of one another. Error reduction component 112 can then utilize a greedy graph coloring algorithm, as shown in more detail in FIG. 3A. The spectator qubits for the gates provide the initial constraints. For each layer in the circuit, error reduction component 112 can start by labeling/coloring the qubits participating in ECR: a first label type for control and second label type for target, wherein different label types or colors correspond to different Walsh-Hadamard sequences. This ensures that the control spectator is not labeled the first label type, and thus its echoes will be staggered with that of the control itself. Additionally, this ensures that the target spectator is not labeled the second label type, and thus Z suppression on the spectator without undoing the effect of rotary pulses at cancelling ZZ between the target and the spectator during those intervals. From there, error reduction component 112 can label the rest of the idle nodes via a greedy assignment beginning with those already constrained by the labeling/coloring of adjacent ECR gates, ensuring that no two neighbors in the crosstalk graph are labeled the same. Whenever there is a conflict and the desired label type cannot be applied, error reduction component 112 can use the next level of the Walsh-Hadamard hierarchy as illustrated in FIG. 3B. This heuristically minimizes the number of DD pulses by staying in the lower levels of the Walsh hierarchy yet ensures that adequate crosstalk suppression is achieved on all parts. A full algorithm for context aware DD selection is provided in FIG. 14.

In one or more embodiments, error reduction component 112 can compensate for noise errors by compiling the inverse of the noise error into the quantum circuit based on the context of the quantum circuit. Error compensation (EC) can comprise absorbing the inverse of the errors into gates preceding or following the error. While the concept of EC is simple, utilizing it requires attention to the context of the circuit. In some cases, the EC can be done with no overhead (e.g., does not increase the runtime of the circuit). Errors previously discussed such as R_{z}(θ) and R_{zz}(θ) can be inverted and compensated by applying R_{z}(−θ) and R_{zz}(−θ) respectively. The former is a single qubit rotation that can be performed virtually in the controller. Accordingly, it generally does not have overhead. A single qubit gate from [symbol] (2) can be implemented using the standard Euler angles and a basis of R_{z} and \sqrt{X} rotations. Specifically, an arbitrary single qubit gate U can be decomposed as U=R_{z}(α+π)\sqrt{X}R_{z}(β+π)\sqrt{X}R_{z}(γ), where α, β, γ are Euler angles. Now consider a single-qubit coherent error R_{z}(θ) that has occurred before U. It is straightforward to see that this error can be compensated by modifying α→α→θ. More general single qubit errors can be compensated similarly by adjusting the Euler angles. An arbitrary two-qubit gate U in [symbol] (4) can be implemented using 3 elementary CNOT gates. Operations of the form U_{can}=exp[i(αX ⊗X+βY ⊗Y+γZ ⊗Z)]show that a R_{zz}(θ) error can be compensated by absorbing its inverse through modifying γ to γ−θ/2. In certain cases, with layered circuits, there might be single qubit gates between the R_{zz}(θ) error and the compensating gate. However, when those single qubit gates are Pauli gates (e.g., I, X, Z, or Z), the compensation angle will change sign if Z ⊗Z and the Pauli term P ⊗Q do not commute.

Accordingly, error reduction component 112 can receive the dictionary mappings from error detection component 110. Error reduction component 112 can then scan over the scheduled circuit layer by layer and identify how correlated errors affect each of the entries in our map. This is done in accordance with the error cases discussed in relation to FIG. 2. Considering the ZZ rates and the duration of each layer, error reduction component 112 can determine compensation angles affecting each entry in the dictionary and add to the one accumulated so far. When the compensation dictionary is passed to the next layer, a twirl layer may be passed through. Depending on where the twirl Paulis commute or anti-commute with each of the Z or ZZ compensations, error reduction component 112 can keep the compensation angle's sign or flip it. If error reduction component 112 reaches a layer where an entry in the compensation dictionary can no longer be commuted through, error reduction component 112 can look at the succeeding gate (and more gates downstream if supported on the same qubits) to see if the compensation can be absorbed into those existing gates. This is the case, for example, when the succeeding gate is itself a ZZ rotation (as in QAOA or Ising model application) or a more general Heisenberg or [symbol] (4) gate, in which case a ZZ can be absorbed into it at no [symbol] additional overhead cost. Otherwise, error reduction component 112 can explicitly insert the compensation as a gate into the circuit. Error reduction component 112 can reset the compensation for this entry of the dictionary and proceed to the next layer. Error reduction component 112 can repeat until all scheduled circuit layers are exhausted.

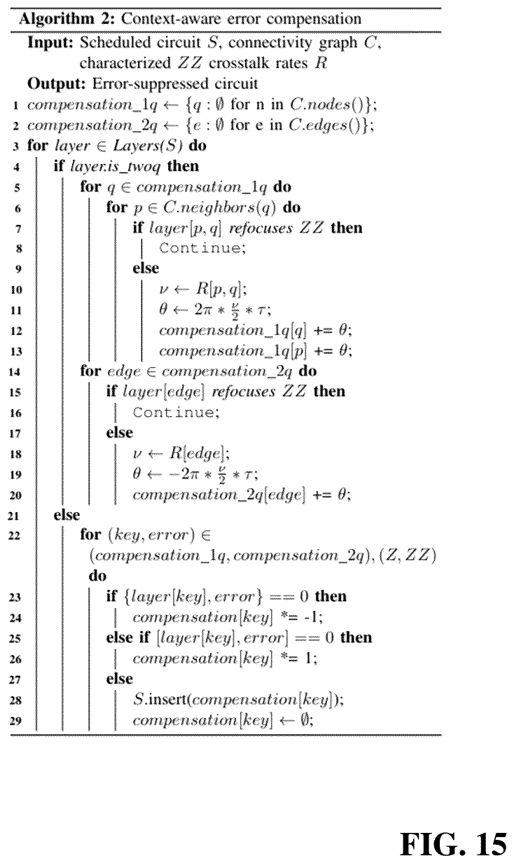

To avoid introducing extra errors from the compensating gates themselves, error reduction component 112 can perform a further optimization. In these cases, observing that the compensating angle is often small, error reduction component 112 can use pulse stretching to natively implement ZZ(θ), which saves substantially on gate error compared to implementing it from two CNOT gates due to having a much shorter pulse. A full algorithm for error compensation is provided in FIG. 15. It should be appreciated that error reduction component 112 can perform both the error suppression utilizing DD and the error compensation as described above. For example, in some embodiments error compensation can be utilized to refocus coherent noise that occurs during gate applications and DD can be utilized to suppress coherent and incoherent noise sources.

FIG. 3A illustrates an example 301 of error suppression for a quantum circuit utilizing context aware DD as described herein in accordance with one or more embodiments and FIG. 3B illustrates seven label types and corresponding Walsh-Hadamard sequences utilized for error suppression in accordance with one or more embodiments described herein.

As described above in relation to FIG. 1, error reduction component 112 can utilize a greedy coloring algorithm to label idle periods within the quantum circuit. For example, control spectators (referred to as ctrl spec.) can be labeled with the second label type 320 (e.g., the second Walsh-Hadamard sequence) and target spectator (referred to as tgt spec.) can be labeled with the first second label type 310 (e.g., the first Walsh-Hadamard sequence). If a conflict occurs, then error reduction component 112 can use the next label type in the list of Walsh-Hadamard sequences. For example, at circuit layer 302 there is a conflict for qubit Q3 as neither the first label type 310 or the second label type 320 can be utilized as Q3 is both a target and control spectator. Therefore, error reduction component 112 can proceed to the next label type/sequence in the list, third label type 330. Similarly, as the same label type/sequence cannot be used on neighboring qubits at the same layer, Q4 has been assigned the second label type 320 at layer 303 and Q5 has been assigned the third label type 330 at layer 303 to allow the first label type 310 to be assigned to Q3 at layer 303.

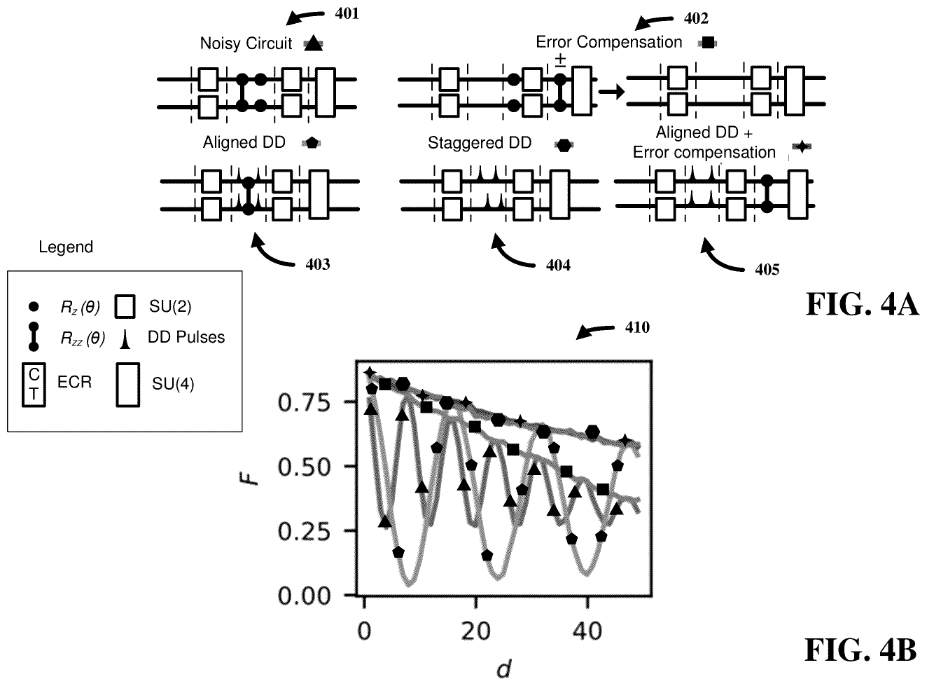

FIGS. 4A-7A illustrate examples of noisy circuits wherein the noise errors have been suppressed and/or compensated using one or more techniques described herein. FIGS. 4B-7B illustrate graphs comparing the performance of the noisy circuits with those generated using the one or more suppression and/or compensation techniques described herein.

Turning to FIG. 4A, circuit 401 illustrates a noisy circuit of Case I as described above in relation to FIG. 2. Circuit 402 illustrates a circuit wherein error reduction component 112 has performed error compensation as described above in relation to FIG. 1. As shown, the inverse of the R_{zz}(θ) has been absorbed into succeeding gates to compensate for the error. Circuit 403 illustrates a case of error suppression utilizing aligned DD pulses. Circuit 404 illustrates a case of error suppression utilizing staggered DD pulses as described above in relation to the coloring algorithm described in FIG. 1. Circuit 405 illustrates a case of utilizing both error compensation and error suppression as described above in relation to FIG. 1. FIG. 4B illustrates a graph 410 comparing the performance of Circuits 401-405. The x-axis of graph 410 represents the number of idle intervals within the circuit (e.g., the number of areas of the circuit that can generate errors) and the y-axis represents the accuracy of the circuit, wherein a higher value is more accurate. As shown in graph 410, Noisy circuit 401 has poor and varying performance. Similarly, circuit 403 has poor and varying performance as the aligned DD pulses can cancel one and other out. In contrast, the circuits using error compensation and error suppression techniques as described herein (e.g., circuits 402, 404 and 405) exhibit both improved accuracy and do not suffer from large fluctuations as circuits 401 and 403 do.

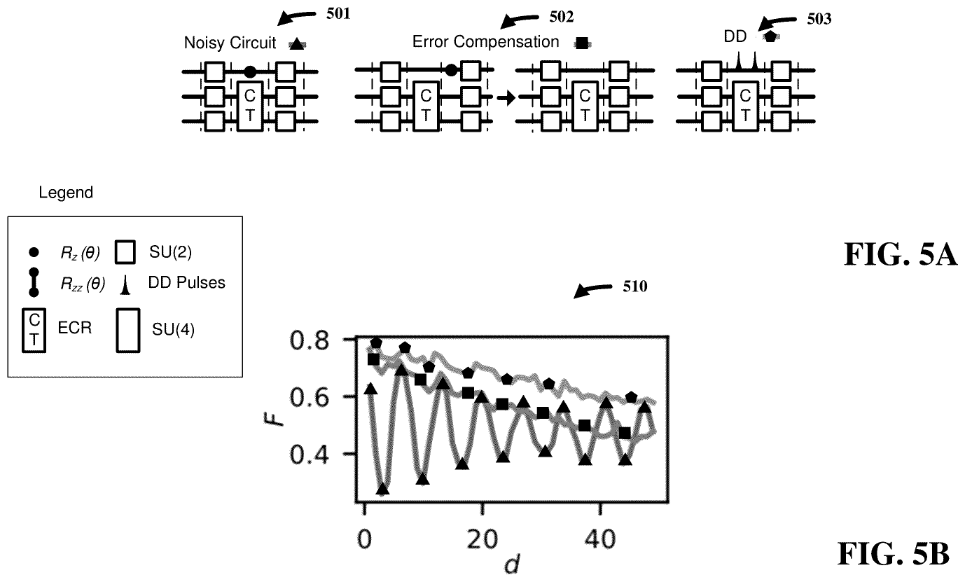

Turning to FIG. 5A, circuit 501 illustrates a noisy circuit of Case II as described above in relation to FIG. 2. Circuit 502 illustrates a circuit wherein error reduction component 112 has performed error compensation as described above in relation to FIG. 1. Circuit 503 illustrates a case of error suppression utilizing DD pulses as described above in relation to the coloring algorithm described in FIG. 1. FIG. 5B illustrates a graph 510 comparing the performance of Circuits 501-503. The x-axis of graph 510 represents the number of idle intervals within the circuit (e.g., the number of areas of the circuit that can generate errors) and the y-axis represents the accuracy of the circuit, wherein a higher value is more accurate. As shown in graph 510, Noisy circuit 501 has poor and varying performance. In contrast, the circuits using error compensation and error suppression techniques as described herein (e.g., circuits 502 and 503) exhibit both improved accuracy and do not suffer from large fluctuations.

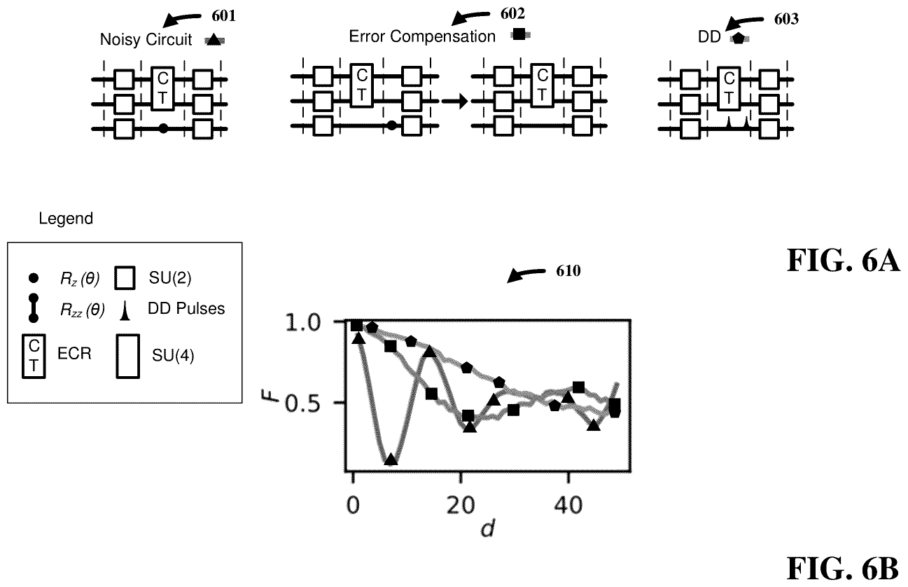

Turning to FIG. 6A, circuit 601 illustrates a noisy circuit of Case III as described above in relation to FIG. 2. Circuit 602 illustrates a circuit wherein error reduction component 112 has performed error compensation as described above in relation to FIG. 1. Circuit 603 illustrates a case of error suppression utilizing DD pulses as described above in relation to the coloring algorithm described in FIG. 1. FIG. 6B illustrates a graph 610 comparing the performance of Circuits 601-603. The x-axis of graph 610 represents the number of idle intervals within the circuit (e.g., the number of areas of the circuit that can generate errors) and the y-axis represents the accuracy of the circuit, wherein a higher value is more accurate. As shown in graph 610, Noisy circuit 601 has poor and varying performance. In contrast, the circuits using error compensation and error suppression techniques as described herein (e.g., circuits 602 and 603) exhibit both improved accuracy and do not suffer from large fluctuations.

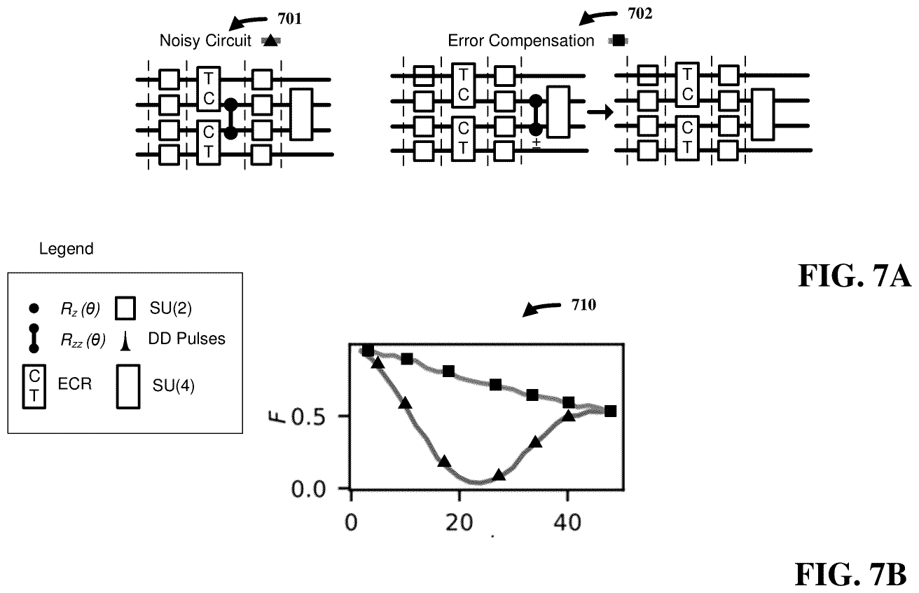

Turning to FIG. 7A, circuit 701 illustrates a noisy circuit of Case IV as described above in relation to FIG. 2. Circuit 702 illustrates a circuit wherein error reduction component 112 has performed error compensation as described above in relation to FIG. 1. FIG. 7B illustrates a graph 710 comparing the performance of Circuits 701-702. The x-axis of graph 710 represents the number of idle intervals within the circuit (e.g., the number of areas of the circuit that can generate errors) and the y-axis represents the accuracy of the circuit, wherein a higher value is more accurate. As shown in graph 710, Noisy circuit 701 has poor and varying performance. In contrast, the circuit using error compensation techniques as described herein (e.g., circuit 702) exhibits both improved accuracy and does not suffer from large fluctuations.

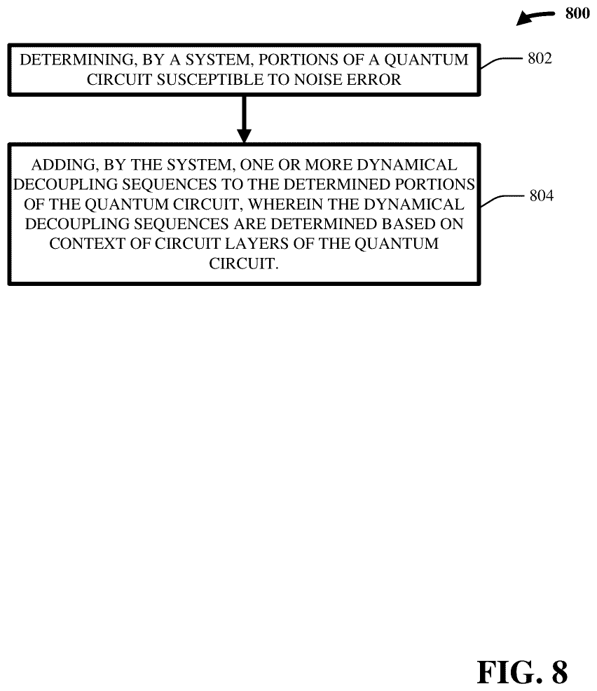

FIG. 8 illustrates a flow diagram of an example, non-limiting, computer implemented method 800 that facilitates suppression of noise errors in accordance with one or more embodiments described herein. Repetitive description of like elements employed in other embodiments described herein is omitted for sake of brevity.

At 802, method 800 can comprise determining, by a system (e.g., quantum noise suppression system 102 and/or error detection component 110) operatively coupled to a processor (e.g., processor 106), one or more portions of a quantum circuit susceptible to noise errors. For example, as described above in greater detail in reference to FIG. 1, error detection component 110 can use the temporal and spatial context of the quantum circuit (e.g., the circuit layers and what gates or operations are being performed at said circuit layers) to determine portions of the quantum circuit that are likely to introduce different types of noise errors. These portions can be determined based on characterizing portions of the quantum circuit as likely to produce specific error cases, such as error Cases I-IV described above in relation to FIG. 2.

At 804, method 800 can comprise adding, by the system (e.g., quantum noise suppression system 102 and/or error reduction component 112, one or more dynamical decoupling sequences to the determined portions of the quantum circuit, wherein the dynamical decoupling sequences are determined based on the context of circuit layers of the quantum circuit. For example, as described above in relation to FIGS. 1 and 3A, error reduction component 112 can utilize a coloring algorithm to label nodes of a crosstalk graph of the quantum circuit. Error reduction component 112 can then utilize a greedy coloring algorithm to assign DD sequences to portions of the quantum circuit. This coloring algorithm allows for error reduction component 112 to utilize the spatial and temporal context of the quantum circuit to add DD sequence that will not conflict with one another at specific layers of the circuit. For example, as described above in relation to FIGS. 1 and 3A, error reduction component 112 can determine if the label type assigned to an idle node would cause a conflict (e.g., is a neighbor already assigned the same label type). In response to a YES determination, error reduction component 112 can use the next label type/level of the Walsh-Hadamard hierarchy, as described in FIG. 3B. In response to a NO determination, error reduction component 112 can add the DD sequence associated with the label type/Walsh-Hadamard hierarchy and proceed to the next idle node. Accordingly, error reduction component 112 can avoid conflicting DD sequences during error suppression, thereby improving circuit fidelity.

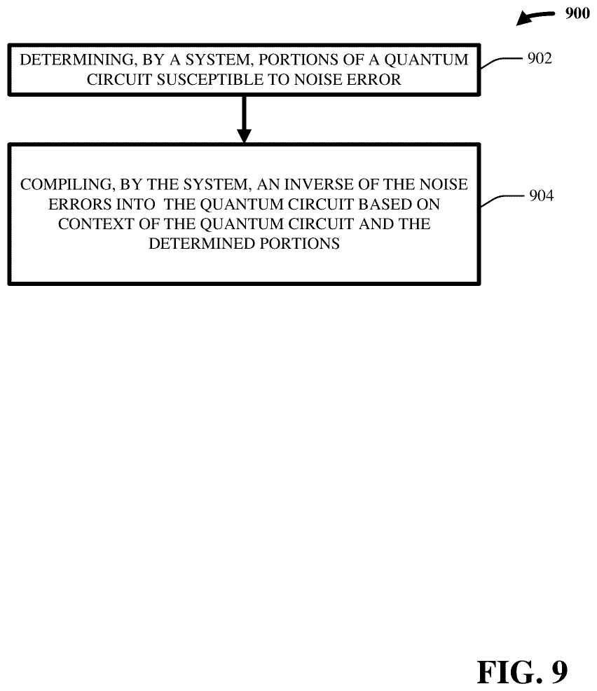

FIG. 9 illustrates a flow diagram of an example, non-limiting, computer implemented method 900 that facilitates compensation of noise errors in accordance with one or more embodiments described herein. Repetitive description of like elements employed in other embodiments described herein is omitted for sake of brevity.

At 902, method 900 can comprise determining, by a system (e.g., quantum noise suppression system 102 and/or error detection component 110) operatively coupled to a processor (e.g., processor 106), one or more portions of a quantum circuit susceptible to noise errors. For example, as described above in greater detail in reference to FIG. 1, error detection component 110 can use the temporal and spatial context of the quantum circuit (e.g., the circuit layers and what gates or operations are being performed at said circuit layers) to determine portions of the quantum circuit that are likely to introduce different types of noise errors. These portions can be determined based on characterizing portions of the quantum circuit as likely to produce specific error cases, such as error Cases I-IV described above in relation to FIG. 2.

At 904, method 900 can comprise compiling, by the system (e.g., error reduction component 112) an inverse of the noise errors into the quantum circuit based on context of the quantum circuit and the determined portions. For example, as described above in greater detail in relation to FIG. 1, error reduction component 112 can determine if the inverse of an error can be absorbed into an existing gate. In response to a YES determination, error reduction component 112 can select one or more appropriate gates that precede or succeed the occurrence of the error and an inverse of the error can be absorbed into the selected gates. In some cases, there can be intermediate gates between the occurrence of the error and the absorption. In response to a NO determination, error reduction component 112 can insert the compensation as a gate into the quantum circuit. In this manner, certain types of errors can be compensated for with few or no additional gates, thereby increasing circuit fidelity, while having minimal impact on circuit overhead (e.g., execution time).

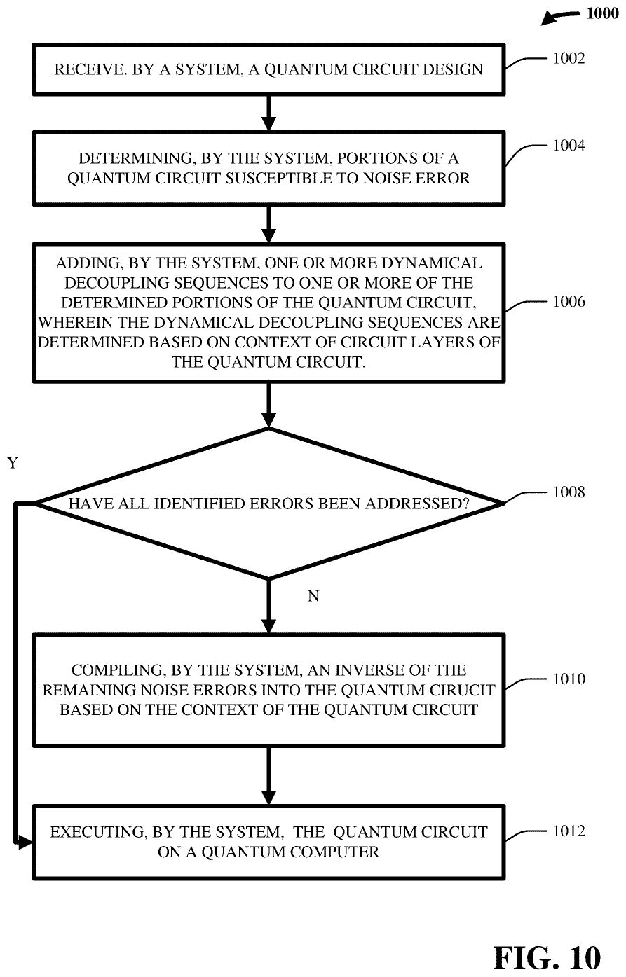

FIG. 10 illustrates a flow diagram of an example, non-limiting, computer implemented method 10000 that facilitates compensation and suppression of noise errors in accordance with one or more embodiments described herein. Repetitive description of like elements employed in other embodiments described herein is omitted for sake of brevity.

At 1002 method 1000 can comprise receiving, by a system (e.g., quantum noise suppression system 102 and/or error detection component 110) operatively coupled to a processor (e.g., processor 106), a quantum circuit design. For example, the design can comprise both a circuit diagram and specifications for the quantum hardware that will be utilized to execute the quantum circuit.

At 1004, method 1000 can comprise determining, by a system (e.g., quantum noise suppression system 102 and/or error detection component 110) operatively coupled to a processor (e.g., processor 106), one or more portions of a quantum circuit susceptible to noise errors. For example, as described above in greater detail in reference to FIG. 1, error detection component 110 can use the temporal and spatial context of the quantum circuit (e.g., the circuit layers and what gates or operations are being performed at said circuit layers) to determine portions of the quantum circuit that are likely to introduce different types of noise errors. These portions can be determined based on characterizing portions of the quantum circuit as likely to produce specific error cases, such as error Cases I-IV described above in relation to FIG. 2.

At 1006, method 1000 can comprise adding, by the system (e.g., quantum noise suppression system 102 and/or error reduction component 112), one or more dynamical decoupling sequences to the determined portions of the quantum circuit, wherein the dynamical decoupling sequences are determined based on the context of circuit layers of the quantum circuit. For example, as described above in relation to FIGS. 1 and 3A, error reduction component 112 can utilize a coloring algorithm to label nodes of a crosstalk graph of the quantum circuit to add DD sequences to the circuit. This coloring algorithm allows for error reduction component 112 to utilize the spatial and temporal context of the quantum circuit to add DD sequence that will not conflict with one another at specific layers of the circuit, thereby improving circuit fidelity.

At 1008, method 1000 can comprise determining, by the system, (e.g., quantum noise suppression system 102 and/or error reduction component 112), if all identified errors in the quantum circuit have been addressed. For example, there may be portions of the circuit that are susceptible to error types that cannot be suppressed through DD. In response to a YES determination (e.g., all errors have been suppressed) method 1000 can proceed to step 1012 and execute the quantum circuit on quantum hardware. In response to a NO determination, method 1000 can proceed to step 1010.

At 1010, method 1000 can comprise compiling, by the system (e.g., error reduction component 112) an inverse of the noise errors into the quantum circuit based on context of the quantum circuit and the remaining determined portions. For example, as described above in greater detail in relation to FIG. 1, an inverse of the error can be absorbed into selected gates that precede or succeeding the occurrence of the error, possibly with intermediate gates between the occurrence of the error and the absorption. In this manner, certain types of errors can be compensated for without the need for additional gates, thereby increasing circuit fidelity, while having minimal impact on circuit overhead (e.g., execution time). After step 1010, method 1000 can proceed to step 1012 and execute the quantum circuit on quantum hardware. By utilizing both error suppression and error correction, circuit fidelity can be improved to a greater extent than with just one method. In one or more embodiments, a user can specify for a particular method (e.g., error suppression or error compensation) to be used for a specific case or characterization of error. For example, a user may specify that a Case II error be addressed with error compensation while a Case III error be addressed with error suppression. While method 1000 illustrates error suppression being performed before error compensation, it should be appreciated that use of error compensation before error suppression and/or simultaneous use of error suppression and error compensation are envisioned. For example, in some embodiments, error compensation can be performed, and then any remaining error can be addressed via error suppression. In some embodiments, the standalone use of error suppression or error compensation can be determined based on the characterization of the errors identified by error detection component 110. For example, a user may specify that only error suppression or error compensation are used, the order of which error suppression and error compensation are used, and/or which cases of errors are addressed by error suppression and/or error compensation.

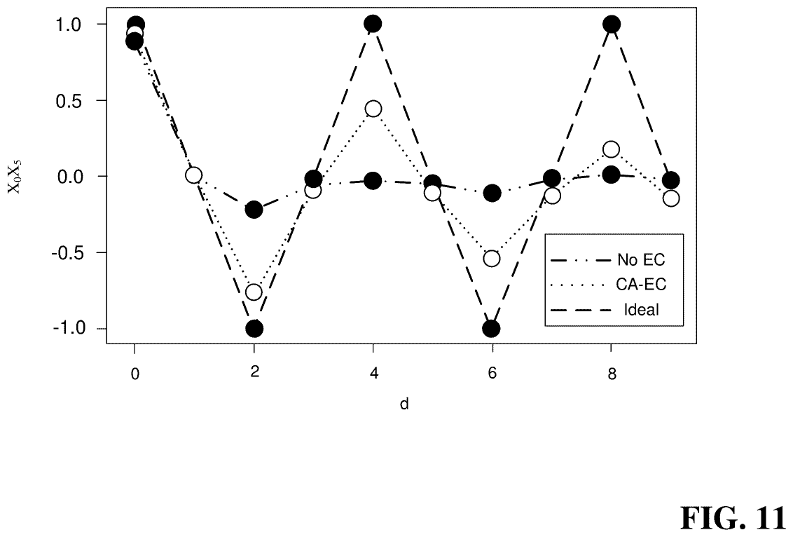

FIG. 11 illustrates a graph 1100 comparing the performance of a Floquet Ising evolution with and without error compensation in accordance with one or more embodiments described herein. The circuit for the Floquet Ising model consists of d steps, each with two layers of two-qubit gates, and a layer of single qubit gates, wherein the two-qubit gates are Pauli-twirled. As shown, when using error compensation as described herein, the results are closer to the ideal results in comparison to no error compensation.

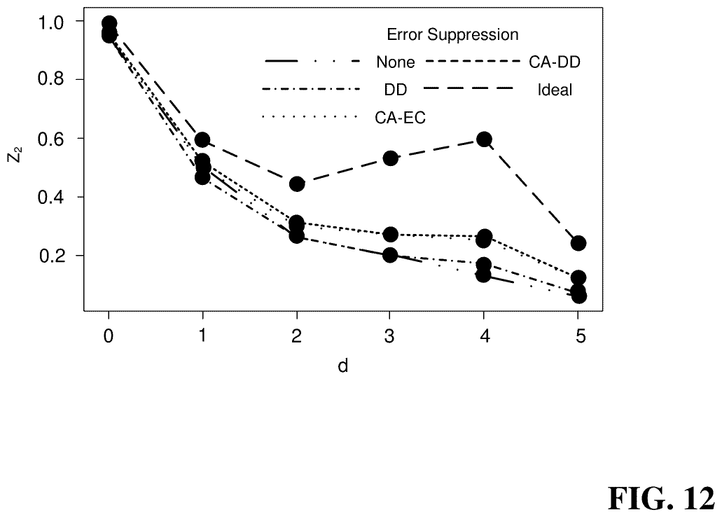

FIG. 12 illustrates a graph 1200 comparing the performance of a Heisenberg model using error suppression and error compensation as described herein and existing methods. As shown, context-aware dynamical decoupling and context aware error compensation as described herein provide results closer to the ideal in comparison to typical dynamical decoupling or no error compensation.

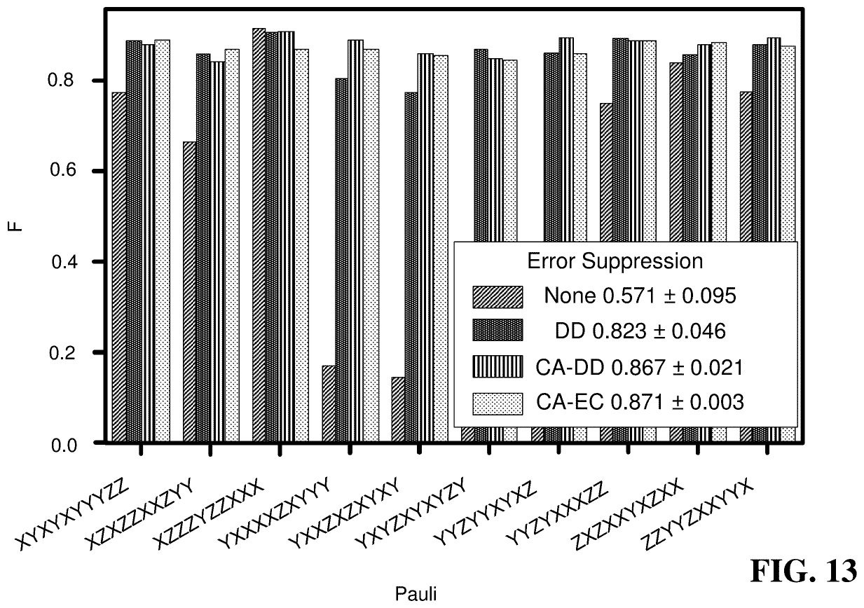

FIG. 13 illustrates a graph 1300 comparing performance benchmarks of fidelity of a 10 qubit with 3 ECR gates and 4 idle qubits in accordance with one or more embodiments described herein. When averaged together, no error compensation or suppression gives a fidelity of 0.571±0.095, non-context aware DD provides a fidelity of 0.823±0.046, context aware DD, as described herein, provides a fidelity of 0.867±0.021 and context aware error compensation, as described herein, provides a fidelity of 0.871±0.003. The improvement of fidelity of context aware DD and context aware error compensation in comparison to exiting DD methods, translates to a reduction in sampling overhead for mitigating errors in a single layer by a factor of 1.25 times. This leads to fewer circuits needing to be sampled during execution, and thus faster overall execution of circuits.

Quantum noise suppression system 102 can provide technical improvements to a quantum hardware associated with quantum noise suppression system 102. For example, by improving circuit fidelity through the methods described herein, the number of execution cycles of the quantum circuit utilized to achieve accurate results can be decreased, thereby decreasing the workload of the quantum hardware that executes the quantum circuit. Furthermore, in comparison to other error mitigation strategies, the methods described herein can improve circuit fidelity while adding few or no additional gates to the quantum circuit. By reducing the number of gates added to the quantum circuit, the workload of the quantum hardware that executes the quantum circuit is decreased as less gates are executed.

A practical application of quantum noise suppression system 102 is that it allows for improvement of fidelity of quantum circuits utilizing a reduced amount of computing and/or network resources, in comparison to other methods. For example, error mitigation often has high overhead costs, thereby increasing the runtime of quantum circuits. Increased runtime can lead to less accurate results and require more advanced hardware to execute. By suppressing and compensating for noise errors with minimal or no increase in overhead, quantum noise suppression system 102 can reduce the runtime of high-fidelity quantum circuits in comparison to other methods. Therefore, quantum noise suppression system 102 can enable generation of quantum circuits that can be operated with reduced quantum hardware requirements, thus promoting scalability of quantum systems.

It is to be appreciated that quantum noise suppression system 102 can utilize various combination of electrical components, mechanical components, and circuitry that cannot be replicated in the mind of a human or performed by a human as the various operations that can be executed by quantum noise suppression system 102 and/or components thereof as described herein are operations that are greater than the capability of a human mind. For instance, the amount of data processed, the speed of processing such data, or the types of data processed by quantum noise suppression system 102 over a certain period of time can be greater, faster, or different than the amount, speed, or data type that can be processed by a human mind over the same period of time. According to several embodiments, quantum noise suppression system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that quantum noise suppression system 102 can include information that is impossible to obtain manually by an entity, such as a human user. For example, the type, amount, and/or variety of information included in quantum noise suppression system 102 can be more complex than information obtained manually by an entity, such as a human user.

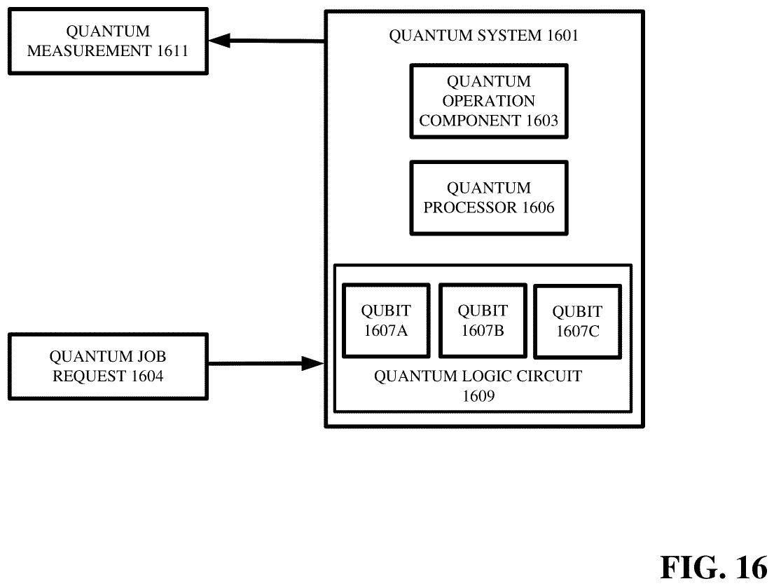

Turning generally to FIG. 16, one or more embodiments described herein can include one or more devices, systems and/or apparatuses that can facilitate executing one or more quantum operations to facilitate output of one or more quantum results. For example, FIG. 16 illustrates a block diagram of an example, non-limiting system 1600 that can complete the execution of a quantum job.

The quantum system 1601 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), physical circuit level components, high level components and/or functions. The quantum circuitry can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement 1611, can be responsive to the quantum job request 1604 (e.g., the compact operations schedule produced by scheduling component 104) and associated input data and can be based at least in part on the input data, quantum functions and/or quantum computations.

In one or more embodiments, the quantum system 1601 can comprise one or more quantum components, such as a quantum operation component 1603, a quantum processor 1606 and a quantum logic circuit 16016 comprising one or more qubits (e.g., qubits 1607A, 1607B and/or 1607C), also referred to herein as qubit devices 1607A, 1607B and 1607C. The quantum processor 1606 can be any suitable processor, capable of controlling qubit coherence and the like. The quantum processor 1606 can generate one or more instructions for controlling the one or more processes of the quantum operation component 1603.

The quantum operation component 1603 that can obtain (e.g., download, receive, search for and/or the like) a quantum job request 1604 requesting execution of one or more quantum programs. The quantum operation component 1603 can determine one or more quantum logic circuits, such as the quantum logic circuit 16016, for executing the quantum program. The request 1604 can be provided in any suitable format, such as a text format, binary format and/or another suitable format. In one or more embodiments, the request 1604 can be received by a component other than a component of the quantum system 1601, such as a by a component of a classical system coupled to and/or in communication with the quantum system 1601.

The quantum operation component 1603 can perform one or more quantum processes, calculations and/or measurements for operating one or more quantum circuits on the one or more qubits 1607A, 1607B and/or 1607C. For example, the quantum operation component 1603 can operate one or more qubit effectors, such as qubit oscillators, harmonic oscillators, pulse generators and/or the like to cause one or more pulses to stimulate and/or manipulate the state(s) of the one or more qubits 1607A, 1607B and/or 1607C comprised by the quantum system 1601. That is, the quantum operation component 1603, such as in combination with the quantum processor 1606, can execute operation of a quantum logic circuit on one or more qubits of the circuit (e.g., qubit 1607A, 1607B and/or 1607C). The quantum operation component 1603 can output one or more quantum job results, such as one or more quantum measurements 161616, in response to the quantum job request 1604.

It will be appreciated that the following description(s) refer(s) to the operation of a single quantum program from a single quantum job request. However, it also will be appreciated that one or more of the processes described herein can be scalable, such as execution of one or more quantum programs and/or quantum job requests in parallel with one another.

In one or more embodiments, the non-limiting system 1600 can be a hybrid system and thus can include both one or more classical systems, such as a quantum program implementation system, and one or more quantum systems, such as the quantum system 1601. In one or more other embodiments, the quantum system 1601 can be separate from, but function in combination with, a classical system.

In such case, one or more communications between one or more components of the non-limiting quantum system 1600 and a classical system can be facilitated by wired and/or wireless means including, but not limited to, employing a cellular network, a wide area network (WAN) (e.g., the Internet), and/or a local area network (LAN). Suitable wired or wireless technologies for facilitating the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an ANT, an ultra-wideband (UWB) standard protocol and/or other proprietary and/or non-proprietary communication protocols.

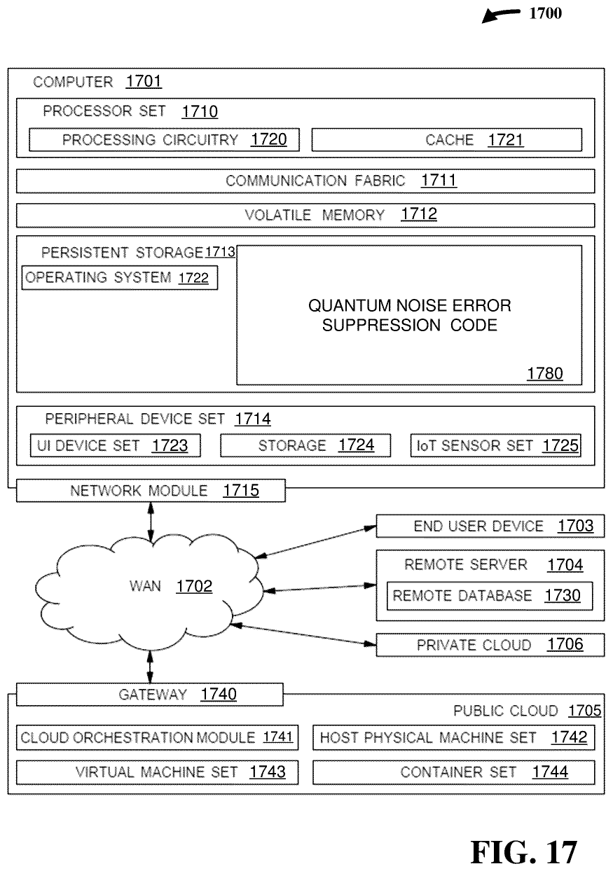

FIG. 17 and the following discussion are intended to provide a brief, general description of a suitable computing environment 1700 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1700 contains an example of an environment for the execution of at least some of the computer code involved in performing the inventive methods, such as translation of an original source code based on a configuration of a target system by the quantum noise error suppression code 1780. In addition to block 1780, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1780, as identified above), peripheral device set 1714 (including user interface (UI), device set 1723, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1730. As is well understood in the art of computer technology, and depending upon the technology, performance of a computer-implemented method can be distributed among multiple computers and/or between multiple locations. On the other hand, in this presentation of computing environment 1700, detailed discussion is focused on a single computer, specifically computer 1701, to keep the presentation as simple as possible. Computer 1701 can be located in a cloud, even though it is not shown in a cloud in FIG. 17. On the other hand, computer 1701 is not required to be in a cloud except to any extent as can be affirmatively indicated.

PROCESSOR SET 1710 includes one, or more, computer processors of any type now known or to be developed in the future. Processing circuitry 1720 can be distributed over multiple packages, for example, multiple, coordinated integrated circuit chips. Processing circuitry 1720 can implement multiple processor threads and/or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set can be located “off chip.” In some computing environments, processor set 1710 can be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods can be stored in block 1780 in persistent storage 1713.

COMMUNICATION FABRIC 1711 is the signal conduction path that allows the various components of computer 1701 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1712 is any type of volatile memory now known or to be developed in the future. Examples include dynamic type random access memory (RAM) or static type RAM. Typically, the volatile memory is characterized by random access, but this is not required unless affirmatively indicated. In computer 1701, the volatile memory 1712 is located in a single package and is internal to computer 1701, but, alternatively or additionally, the volatile memory can be distributed over multiple packages and/or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 and/or directly to persistent storage 1713. Persistent storage 1713 can be a read only memory (ROM), but typically at least a portion of the persistent storage allows writing of data, deletion of data and re-writing of data. Some familiar forms of persistent storage include magnetic disks and solid-state storage devices. Operating system 1722 can take several forms, such as various known proprietary operating systems or open-source Portable Operating System Interface type operating systems that employ a kernel. The code included in block 1780 typically includes at least some of the computer code involved in performing the inventive methods.

PERIPHERAL DEVICE SET 1714 includes the set of peripheral devices of computer 1701. Data communication connections between the peripheral devices and the other components of computer 1701 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1723 can include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 can be persistent and/or volatile. In some embodiments, storage 1724 can take the form of a quantum computing storage device for storing data in the form of qubits. In embodiments where computer 1701 is required to have a large amount of storage (for example, where computer 1701 locally stores and manages a large database) then this storage can be provided by peripheral storage devices designed for storing large amounts of data, such as a storage area network (SAN) that is shared by multiple, geographically distributed computers. IoT sensor set 1725 is made up of sensors that can be used in Internet of Things applications. For example, one sensor can be a thermometer and another sensor can be a motion detector.

NETWORK MODULE 1715 is the collection of computer software, hardware, and firmware that allows computer 1701 to communicate with other computers through WAN 1702. Network module 1715 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701) and can take any of the forms discussed above in connection with computer 1701. EUD 1703 typically receives helpful and useful data from the operations of computer 1701. For example, in a hypothetical case where computer 1701 is designed to provide a recommendation to an end user, this recommendation would typically be communicated from network module 1715 of computer 1701 through WAN 1702 to EUD 1703. In this way, EUD 1703 can display, or otherwise present, the recommendation to an end user. In some embodiments, EUD 1703 can be a client device, such as thin client, heavy client, mainframe computer and/or desktop computer.

REMOTE SERVER 1704 is any computer system that serves at least some data and/or functionality to computer 1701. Remote server 1704 can be controlled and used by the same entity that operates computer 1701. Remote server 1704 represents the machine(s) that collect and store helpful and useful data for use by other computers, such as computer 1701. For example, in a hypothetical case where computer 1701 is designed and programmed to provide a recommendation based on historical data, then this historical data can be provided to computer 1701 from remote database 1730 of remote server 1704.

PUBLIC CLOUD 1705 is any computer system available for use by multiple entities that provides on-demand availability of computer system resources and/or other computer capabilities, especially data storage (cloud storage) and computing power, without direct active management by the scale. The direct and active management of the computing resources of public cloud 1705 is performed by the computer hardware and/or software of cloud orchestration module 1741. The computing resources provided by public cloud 1705 are typically implemented by virtual computing environments that run on various computers making up the computers of host physical machine set 1742, which is the universe of physical computers in and/or available to public cloud 1705. The virtual computing environments (VCEs) typically take the form of virtual machines from virtual machine set 1743 and/or containers from container set 1744. It is understood that these VCEs can be stored as images and can be transferred among and between the various physical machine hosts, either as images or after instantiation of the VCE. Cloud orchestration module 1741 manages the transfer and storage of images, deploys new instantiations of VCEs and manages active instantiations of VCE deployments. Gateway 1740 is the collection of computer software, hardware and firmware allowing public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1706 is similar to public cloud 1705, except that the computing resources are only available for use by a single enterprise. While private cloud 1706 is depicted as being in communication with WAN 1702, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system comprising:
a memory that stores computer executable components;
a processor that executes the computer executable components stored in the memory, wherein the computer executable components comprise:
an error detection component that determines one or more portions of a quantum circuit susceptible to noise errors; and
an error reduction component that adds one or more dynamical decoupling sequences to the one or more determined portions of the quantum circuit wherein the one or more dynamical decoupling sequences are determined based on context of circuit layers of the quantum circuit.

2. The system of claim 1, wherein the context comprises temporal and spatial configuration of the quantum circuit.

3. The system of claim 1, wherein the one or more dynamical decoupling sequences are determined based on specifications of quantum hardware assigned to execute the quantum circuit.

4. The system of claim 1, wherein the one or more dynamical decoupling sequences are determined using a coloring algorithm that labels a crosstalk graph based on characteristics of quantum hardware and the circuit layers.

5. The system of claim 1, wherein the one or more dynamical decoupling sequences are non-conflicting.

6. The system of claim 5, wherein the one or more dynamical decoupling sequences comprise Walsh-Hadamard DD sequences.

7. The system of claim 1, wherein the one or more dynamical decoupling sequences improve fidelity of execution of the quantum circuit and reduce overhead of error mitigation.

8. A computer implemented method comprising:
determining, by a system operatively coupled to a processor, one or more portions of a quantum circuit susceptible to noise errors; and
adding, by the system, one or more dynamical decoupling sequences to the one or more determined portions of the quantum circuit, wherein the one or more dynamical decoupling sequences are determined based on context of circuit layers of the quantum circuit.

9. The computer implemented method of claim 8, wherein the context comprises temporal and spatial configuration of the quantum circuit.

10. The computer implemented method of claim 8, wherein the one or more dynamical decoupling sequences are determined based on specifications of quantum hardware assigned to execute the quantum circuit.

11. The computer implemented method of claim 8, wherein the one or more dynamical decoupling sequences are determined using a coloring algorithm that labels a crosstalk graph based on characteristics of quantum hardware and the circuit layers.

12. The computer implemented method of claim 8, wherein the one or more dynamical decoupling sequences are non-conflicting.

13. The computer implemented method of claim 12, wherein the one or more dynamical decoupling sequences comprise Walsh-Hadamard DD sequences.

14. The computer implemented method of claim 8, wherein the one or more dynamical decoupling sequences improve fidelity of execution of the quantum circuit and reduce overhead of error mitigation.

15. A computer program product, comprising a computer readable storage medium having program instructions embodied therewith, the program instructions executable by a processor to cause the processor to:
determine, by the processor, one or more portions of a quantum circuit susceptible to noise errors; and
add, by the processor, one or more dynamical decoupling sequences to the one or more determined portions of the quantum circuit, wherein the one or more dynamical decoupling sequences are determined based on context of circuit layers of the quantum circuit.

16. The computer program product of claim 15, wherein the context comprises temporal and spatial configuration of the quantum circuit.

17. The computer program product of claim 15, wherein the one or more dynamical decoupling sequences are determined based on specifications of quantum hardware assigned to execute the quantum circuit.

18. The computer program product of claim 15, wherein the one or more dynamical decoupling sequences are determined using a coloring algorithm that labels a crosstalk graph based on characteristics of quantum hardware and the circuit layers.

19. The computer program product of claim 15, wherein the one or more dynamical decoupling sequences are non-conflicting.

20. The computer program product of claim 15, wherein the one or more dynamical decoupling sequences improve fidelity of execution of the quantum circuit and reduce overhead of error mitigation.
